(19) United States
(12) Patent Application Publication
(10) Pub. No.: US 2026/0051582 A1
(43) Pub. Date: Feb. 19, 2026

(54) CAP ASSEMBLY, SECONDARY BATTERY AND METHOD FOR MANUFACTURING CAP ASSEMBLY

(71) Applicant: SAMSUNG SDI CO., LTD., Yongin-si (KR)

(72) Inventor: Taewoong JANG, Yongin-si (KR)

(21) Appl. No.: 19/013,231

(22) Filed: Jan. 8, 2025

(30) Foreign Application Priority Data
Aug. 13, 2024 (KR) 10-2024-0108164

(51) Int. Cl. H01M 50/16; H01M 50/164; H01M 50/172

(52) U.S. Cl. CPC H01M 50/16; H01M 50/164; H01M 50/172

(57) ABSTRACT

A cap assembly includes a cap plate having a terminal hole therein, a terminal plate inserted into the terminal hole and joined to an upper portion of the cap plate, and an insulator between the cap plate and the terminal plate, the insulator including an aromatic polyamide and a resin composition.

### CROSS-REFERENCE TO RELATED APPLICATION

This application claims priority under 35 U.S.C § 119 to Korean Patent Application No. 10-2024-0108164, filed in the Korean Intellectual Property Office on Aug. 13, 2024, the entire contents of which are hereby incorporated by reference.

### BACKGROUND

### 1. Field

Aspects of embodiments of the present disclosure relate to a cap assembly, a secondary battery, and a method for manufacturing the cap assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of embodiments provide a cap assembly including a cap plate having a terminal hole formed therein, a terminal plate inserted into the terminal hole and joined to an upper portion of the cap plate, and an insulator positioned between the cap plate and the terminal plate and including aromatic polyamide and a resin composition.

According to an embodiment, the insulator may include an insulating layer formed by impregnating aromatic polyamide with a resin composition, and an adhesive layer formed on at least one surface of the insulating layer.

According to an embodiment, the insulating layer may include aromatic polyamide having a plurality of pores extending vertically therethrough.

According to an embodiment, the insulating layer may have a porosity of 10% or more and 90% or less.

According to an embodiment, the insulating layer may be formed by impregnating the resin composition between the plurality of pores.

According to an embodiment, the aromatic polyamide may be formed in a form of a woven fabric in which warp and weft yarns intersect each other.

According to an embodiment, the insulating layer may be formed by stacking a plurality of aromatic polyamide layers.

According to an embodiment, the insulator may be formed to a thickness of 10 μm to 200 μm.

According to an embodiment, the resin composition may include at least one of a polypropylene resin, an acrylic resin, a synthetic rubber resin, a polyolefin resin, an ester resin, a urethane resin, an epoxy resin, or a silicone resin.

Aspects of embodiments provide a secondary battery including: an electrode assembly configured by winding a first electrode, a second electrode, and a separator interposed between the first electrode and the second electrode, a case having an opening formed on one side and accommodating the electrode assembly, a cap assembly joined to one side of the case to seal the case, wherein the cap assembly may include: a cap plate joined to the opening and having a terminal hole formed therein, a terminal plate inserted into the terminal hole, joined to an upper portion of the cap plate, and electrically connected to the first electrode, and an insulator positioned between the cap plate and the terminal plate and including aromatic polyamide and a resin composition.

According to an embodiment, the insulator may include an insulating layer formed by impregnating the resin composition into the aromatic polyamide, and an adhesive layer formed on at least one surface of the insulating layer.

Aspects of embodiments provide a method for manufacturing a cap assembly including: a step of forming an insulator including aromatic polyamide and a resin composition, a step of preparing a cap plate having a terminal hole formed therein, a step of joining the insulator to an upper surface of the cap plate, and a step of joining a terminal plate to an upper portion of the cap plate so as to cover the terminal hole.

According to an embodiment, the step of forming the insulator may include forming an insulating layer by impregnating the resin composition into the aromatic polyamide, and stacking an adhesive layer on at least one surface of the insulating layer.

According to an embodiment, the insulating layer may include the aromatic polyamide having a plurality of pores extending vertically therethrough.

According to an embodiment, the insulating layer may have a porosity of 10% or more and 90% or less.

According to an embodiment, the step of forming the insulating layer may include impregnating the resin composition between the plurality of pores.

According to an embodiment, the aromatic polyamide may be formed in a form of a woven fabric in which warp and weft yarns intersect each other.

According to an embodiment, the step of forming the insulating layer may include stacking a plurality of aromatic polyamide layers.

According to an embodiment, in the step of forming the insulator, the insulator may be formed to a thickness of 10 μm to 200 μm.

According to an embodiment, the resin composition may include at least one of a polypropylene resin, an acrylic resin, a synthetic rubber resin, a polyolefin resin, an ester resin, a urethane resin, an epoxy resin, or a silicone resin.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a perspective view of a secondary battery according to an embodiment of the present disclosure;

FIG. 2 illustrates an exploded perspective view of a secondary battery according to an embodiment of the present disclosure;

FIG. 3 illustrates a cross-sectional view of a secondary battery according to an embodiment of the present disclosure;

FIG. 4 illustrates a cross-sectional view of a cap assembly according to an embodiment of the present disclosure;

FIG. 5 illustrates a cross-sectional view of an insulator according to an embodiment of the present disclosure;

FIG. 6 illustrates a cross-sectional view of an insulator according to another embodiment of the present disclosure;

FIG. 7 illustrates a cross-sectional view of an insulator according to another embodiment of the present disclosure;

FIG. 8 illustrates aromatic polyamide in the form of a woven material as an insulating layer according to an embodiment of the present disclosure;

FIG. 9 illustrates an enlarged view of a region A of FIG. 8 in a case where impregnated with a resin composition;

FIG. 10 illustrates a flowchart showing a method for manufacturing a cap assembly according to an embodiment of the present disclosure;

FIG. 11 illustrates applying a resin melt to aromatic polyamide in a method for manufacturing a cap assembly according to an embodiment of the present disclosure;

FIG. 12 illustrates that the aromatic polyamide is impregnated with a resin melt after FIG. 11; and

FIG. 13 illustrates evaporation of a solvent in a method for manufacturing a cap assembly according to another embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

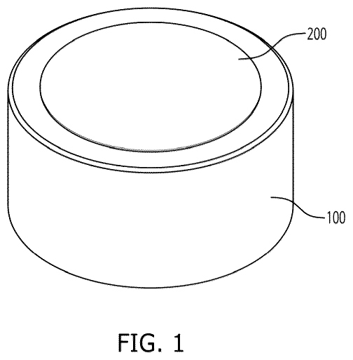

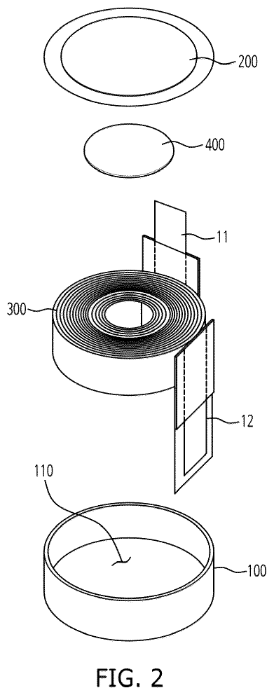

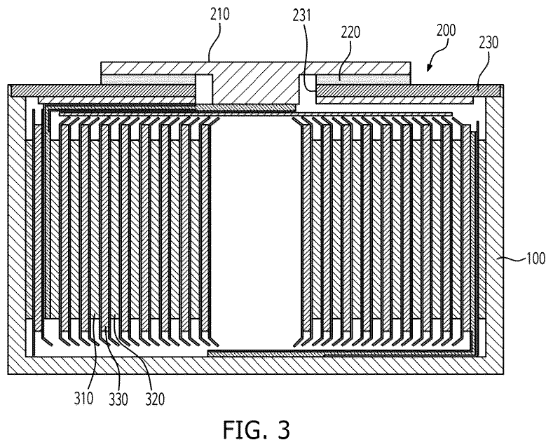

FIG. 1 illustrates a perspective view of a secondary battery according to an embodiment of the present disclosure, and FIG. 2 illustrates an exploded perspective view of the secondary battery according to an embodiment of the present disclosure. FIG. 3 illustrates a cross-sectional view of the secondary battery according to an embodiment of the present disclosure.

As illustrated in FIGS. 1 to 3, the secondary battery may include a case 100, a cap assembly 200, and an electrode assembly 300. In an embodiment, the secondary battery may be a coin-type or button-type secondary battery, e.g., the secondary battery may have a cylindrical shape.

In an embodiment, the case 100 may have an opening 110 formed on one side and configured to accommodate the electrode assembly 300. The case 100 may accommodate the electrode assembly 300 and an electrolyte, and may configure the external appearance of the secondary battery together with the cap assembly 200. For example, the case 100 may include an approximately cylindrical sidewall portion and a bottom portion connected to one side of the sidewall portion. However, the case 100 may be configured in various shapes such as a circular shape and a pouch shape. For example, the case 100 may be composed of metal such as aluminum, an aluminum alloy, stainless steel, or nickel-plated steel, or a laminated film or plastic that constitutes a pouch.

The case 100 may accommodate the electrode assembly 300. The electrode assembly 300 may be inserted into the case 100 through the opening 110 formed in one side thereof. Thereafter, the opening 110 of the case 100 may be closed by the cap assembly 200. The cap assembly 200 may be joined to one side of the case 100.

The cap assembly 200 may be joined to one side of the case 100 to seal the opening 110. The cap assembly 200 may be welded to an area that comes into contact with or is joined to the case 100. In an embodiment, the cap assembly 200 may include a terminal plate 210, an insulator 220, and a cap plate 230. The first terminal plate 210 may be electrically connected to a first electrode tab 11.

The cap plate 230 may be joined to the opening 110 to seal the opening 110 of the case 100. The cap plate 230 may be joined to the side surface of the case 100 corresponding to the side surface of the opening 110.

A terminal hole 231 may be formed in the cap plate 230. Specifically, the terminal hole 231 may be formed approximately at the center of the cap plate 230. At least a portion of the terminal plate 210 may be inserted into the terminal hole 231 and joined to the cap plate 230 with the insulator 220 interposed between the terminal plate 210 and the cap plate 230.

The terminal plate 210 may be inserted into the terminal hole 231 and joined to the upper portion of the cap plate 230. The first terminal plate 210 may be electrically connected to a first electrode 310. The insulator 220 may be positioned between the cap plate 230 and the terminal plate 210. In an embodiment, the insulator 220 may include aromatic polyamide and a resin composition. For example, the insulator 220 may include an insulating layer formed by impregnating aromatic polyamide with a resin composition, and an adhesive layer formed on at least one surface of the insulating layer. The resin composition may include at least one of a polypropylene resin, an acrylic resin, a synthetic rubber resin, a polyolefin resin, an ester resin, a urethane resin, an epoxy resin, or a silicone resin.

The insulator 220 may be arranged between (e.g., directly between) the terminal plate 210 and the cap plate 230. Because the insulator 220 has an adhesive layer on the surface thereof, the insulator 220 may be closely attached to the terminal plate 210 and the cap plate 230, thereby joining (e.g., connecting) the terminal plate 210 to the cap plate 230. The insulator 220 may be composed of an insulating material and may electrically insulate the terminal plate 210 and the cap plate 230 from each other.

By arranging the insulator 220 having such a configuration between the terminal plate 210 and the cap plate 230, the durability of the insulator 220 from external impact may be increased, and thus, a phenomenon that the insulator 220 is damaged and causes a short circuit may be prevented. For example, by increasing the durability of the insulator 220 and adding a waterproof function, it is possible to prevent deterioration of the secondary battery that may occur due to moisture infiltration from the outside.

The electrode assembly 300 may include the first electrode 310, a second electrode 320, and a separator 330. In detail, the electrode assembly 300 may be configured by winding the first electrode 310, the second electrode 320, and the separator 330 interposed between the first electrode 310 and the second electrode 320. The electrode assembly 300 may be wound to form a wound structure with a core portion and may include a through-hole in the core portion.

The first electrode 310 may include a first substrate and a first active material layer positioned on the first substrate. The first electrode tab 11 may extend outward from a first uncoated portion of the first substrate where the first active material layer is not positioned, and the first electrode tab 11 may be electrically connected to the terminal plate 210 of the cap assembly 200. In an embodiment, the first electrode tab 11 may be a positive electrode tab. The first electrode tab 11 may be joined to the first electrode 310.

The second electrode 320 may include a second substrate and a second active material layer positioned on the second substrate. A second electrode tab 12 may extend outward from a second uncoated portion of the second substrate where the second active material layer is not positioned, and the second electrode tab 12 may be electrically connected to the lower inner surface of the case 100. In an embodiment, the second electrode tab 12 may be a negative electrode tab. The second electrode tab 12 may be joined to the second electrode 320. The first electrode tab 11 and the second electrode tab 12 may respectively extend in opposite directions from the first electrode 310 and the second electrode 320.

The first electrode 310 may function as a positive electrode. In this case, the first substrate may be composed of, e.g., aluminum foil, and the first active material layer may include, e.g., a transition metal oxide. The second electrode 320 may function as a negative electrode. In this case, the second substrate may be composed of, e.g., copper foil or nickel foil, and the second active material layer may include, e.g., graphite.

The separator 330 may function to prevent a short circuit between the first electrode and the second electrode while allowing movement of lithium ions. The separator 330 may be composed of, e.g., polyethylene film, polypropylene film, polyethylene-polypropylene film, or the like, but the present disclosure is not limited thereto.

For example, referring to FIG. 2, the first electrode tab 11 of the first electrode may be formed on one side of the electrode assembly 300, and the second electrode tab 12 of the second electrode may be formed on the other side of the electrode assembly 300. In another example, both the first electrode tab 11 and the second electrode tab 12 may be formed on one side of the electrode assembly 300. For example, an insulating sheet 400 may be disposed on the electrode assembly 300 so as to insulate between the upper portion of the electrode assembly 300 and the first electrode tab 11.

In an embodiment, each of the first electrode tab 11 and the second electrode tab 12 may be covered with a cover tape. The cover tape may include an insulating material. The insulating material may provide electrical insulation to prevent current from passing therethrough. A short circuit that may potentially occur between the first electrode tab 11 and the second electrode tab 12 and the surrounding conductive components thereof may be prevented by the cover tape.

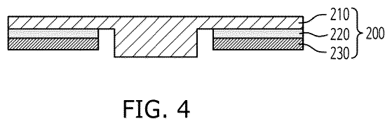

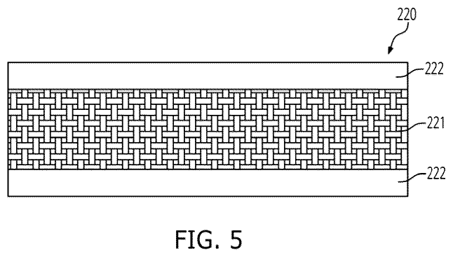

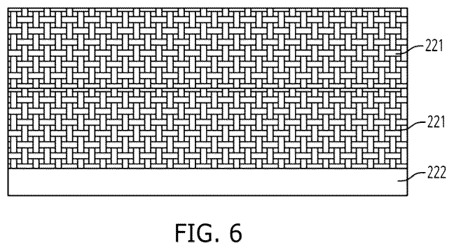

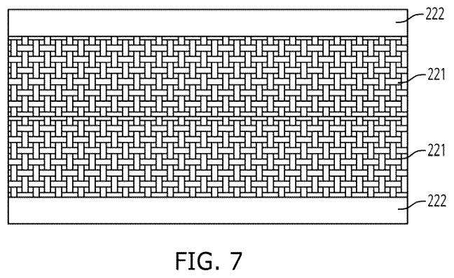

FIG. 4 illustrates a cross-sectional view of the cap assembly 200 according to an embodiment of the present disclosure, FIG. 5 illustrates a cross-sectional view of the insulator 220 according to an embodiment of the present disclosure, FIG. 6 illustrates a cross-sectional view of an insulator according to another embodiment of the present disclosure, and FIG. 7 illustrates a cross-sectional view of an insulator according to still another embodiment of the present disclosure.

Referring to FIGS. 4 to 7, the cap assembly 200 according to an embodiment of the present disclosure may include the terminal plate 210, the insulator 220, and the cap plate 230. The insulator 220 may include an insulating layer 221 and an adhesive layer 222.

The insulating layer 221 may be formed by impregnating aromatic polyamide with a resin composition. The adhesive layer 222 may be formed on at least one surface of the insulating layer 221. For example, as illustrated in FIG. 5, the adhesive layers 222 may be formed on opposite surfaces of the insulating layer 221.

In an embodiment, the insulating layer 221 may be formed by stacking a plurality of aromatic polyamide layers. As illustrated in FIG. 6, in a state where the insulating layer 221 is continuously stacked, the adhesive layer 222 may be formed on (e.g., only) one surface of the insulating layer 221. For example, as illustrated in FIG. 7, in a state where the insulating layer 221 is continuously stacked, the adhesive layer 222 may be formed on two opposite surfaces of the insulating layer 221.

In an embodiment, the insulator 220 may be formed to a thickness of 10 μm to 200 μm, e.g., a total thickness of the insulator 220 including the insulating layer 221 and at least one adhesive layer 222 along a direction normal to the bottom of the electrode assembly 300 may be 10 μm to 200μm. The insulator 220 may be arranged between the terminal plate 210 and the cap plate 230. The insulator 220 may include the adhesive layer 222 on the surface thereof, may be closely attached to the terminal plate 210 and the cap plate 230, and may be joined to the terminal plate 210 to the cap plate 230. The insulator 220 may be composed of an insulating material and may electrically insulate the terminal plate 210 and the cap plate 230 from each other.

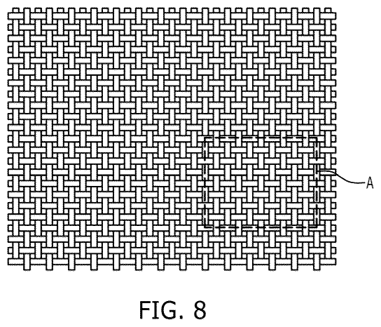

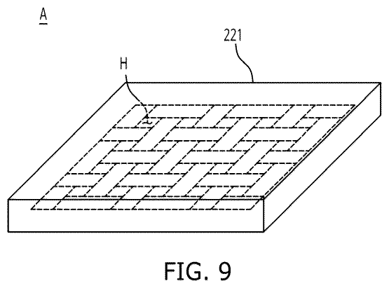

FIG. 8 illustrates an aromatic polyamide in the form of a woven material as an insulating layer according to an embodiment of the present disclosure, and FIG. 9 illustrates an enlarged view of a region A of FIG. 8 in a case where impregnated with a resin composition.

Referring to FIGS. 8 and 9, the insulating layer 221 may include a structure or fabric including aromatic polyamide in which a plurality of pores H vertically passing through the other side opposite to one side are formed. The structure including the aromatic polyamide may have excellent spinnability, high strength, high elasticity, and high heat resistance, compared to general-purpose synthetic fibers such as polyester fibers or aliphatic polyamide fibers.

In an embodiment, the structure of the aromatic polyamide included in the insulating layer 221 may have a porosity of 10% or more and 90% or less. The insulating layer 221 may be formed by impregnating a resin composition between the plurality of pores H formed in the structure of the aromatic polyamide. By impregnating the resin composition between the plurality of pores H of the structure of the aromatic polyamide in the insulating layer 221, not only the strength of the insulating layer 221 may be improved, but also the waterproof function may be secured.

In a case where the structure of the aromatic polyamide has a porosity of less than 10%, it may be difficult for the resin composition to be impregnated into the structure to play a sufficient role in suppressing moisture adsorption. In some embodiments, in a case where the porosity of the structure of the aromatic polyamide exceeds 90%, the tensile strength of the insulating layer 221 may be significantly reduced even in a case where the structure is impregnated with a resin composition, making it vulnerable to external impact.

For example, the aromatic polyamide may be formed in the form of a woven fabric in which warp and weft yarns intersect each other, as illustrated in FIG. 8. The insulating layer 221 may be formed by impregnating the resin composition between the pores H formed in the aromatic polyamide. For example, the resin composition may include at least one of a polypropylene resin, an acrylic resin, a synthetic rubber resin, a polyolefin resin, an ester resin, a urethane resin, an epoxy resin, or a silicone resin.

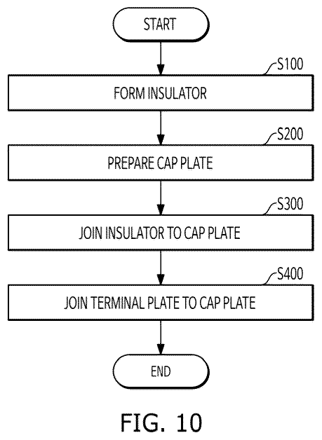

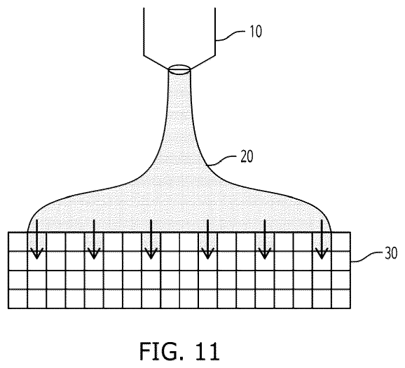

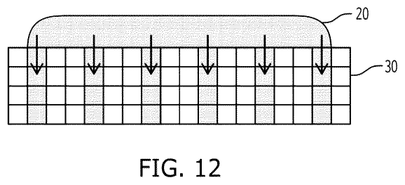

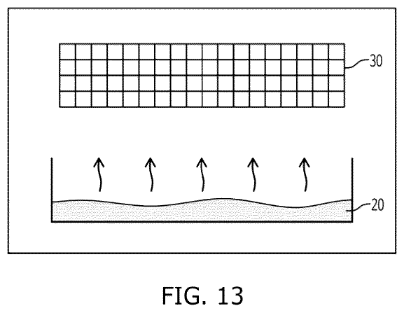

FIG. 10 illustrates a flowchart showing a method for manufacturing a cap assembly according to an embodiment of the present disclosure, FIG. 11 illustrates applying a resin melt to aromatic polyamide in a method for manufacturing a cap assembly according to an embodiment of the present disclosure, FIG. 12 illustrates that the aromatic polyamide is impregnated with a resin melt after FIG. 11, and FIG. 13 illustrates evaporation of a solvent in a method for manufacturing a cap assembly according to another embodiment of the present disclosure.

Referring to FIGS. 10 to 13, a method for manufacturing a cap assembly according to an embodiment of the present disclosure may include forming an insulator (S100), preparing a cap plate (S200), joining the insulator to the cap plate (S300), and a joining a terminal plate to the upper portion of the cap plate (S400).

In an embodiment, forming the insulator (S100) may include forming an aromatic polyamide and a resin composition. In detail, forming the insulator may include forming an insulating layer by impregnating a resin composition into the aromatic polyamide and stacking an adhesive layer on at least one surface of the insulating layer.

In an embodiment, forming the insulator (S100) may include forming the insulator to a thickness of 10 μm to 200 μm. Forming the insulating layer may include stacking a plurality of aromatic polyamide layers.

In an embodiment, the insulating layer may include aromatic polyamide having a plurality of pores extending vertically therethrough. For example, the insulating layer may have a porosity of 10% or more and 90% or less.

In an embodiment, forming the insulating layer may include impregnating a resin composition between the plurality of pores. The resin composition may include at least one of a polypropylene resin, an acrylic resin, a synthetic rubber resin, a polyolefin resin, an ester resin, a urethane resin, an epoxy resin, or a silicone resin. For example, impregnating the resin composition may include applying and impregnating a resin composition melt onto a structure of aromatic polyamide, as illustrated in FIGS. 11 and 12.

According to an embodiment, as illustrated in FIG. 11, a resin composition melt 20 may be applied from the upper portion of an aromatic polyamide structure 30 through a nozzle 10 to impregnate the aromatic polyamide structure 30 positioned thereunder. For example, the aromatic polyamide structure 30 may have the form of a nonwoven fabric woven using an aromatic polyamide material. As illustrated in FIG. 12, a plurality of pores may be formed in the aromatic polyamide structure 30, and the resin composition melt 20 may gradually permeate and impregnate the pores.

As another example, in the step of impregnating the resin composition, as illustrated in FIG. 13, a method of volatilizing a solution of the resin composition dissolved in a solvent and allowing it to penetrate into the aromatic polyamide structure may be used as an impregnation method. For example, as illustrated in FIG. 13, the aromatic polyamide structure 30 may be disposed within a closed chamber. For example, a container containing the resin composition melt 20 dissolved in a solvent may be disposed on the lower side of the polyamide structure 30. Within the chamber configured in this manner, the resin composition melt 20 may be volatilized and may penetrate into the polyamide structure 30 to join to the structure.

Forming the insulator (S100) may include forming the aromatic polyamide in the form of a woven fabric in which warp and weft yarns intersect each other. For example, the aromatic polyamide may be formed by forming an aggregated layer of fibers and then joining the fibers together in a fiber-to-fiber joining process. As the method of forming the aggregated layer of fiber, a dry method, a wet method, a spun-bonded fabric method, and a melt-blown method may be used. However, in the present disclosure, other appropriate methods capable of forming the aggregated layer of fibers may be used. As the inter-fiber joining method, a thermal bond method, a chemical bond method, a needle-punch method, and a spunlace method may be used. However, other appropriate inter-fiber joining methods may be used. The chemical bonding method may include an impregnation method and a spray method. According to the spray method, fiber-to-fiber joining may be achieved using a small amount of adhesive.

According to an embodiment, preparing the cap plate (S200) may include forming a terminal hole in the cap plate. For example, joining the insulator (S300) may include joining the insulator to the upper surface of the cap plate. Joining the terminal plate to the cap plate (S400) may include joining the terminal plate to the upper portion of the cap plate, e.g., the terminal plate may be joined to the upper portion of the cap plate so as to cover the terminal hole.

For example, referring to FIGS. 1 to 3, the terminal hole 231 may be formed in the cap plate 230. Specifically, the terminal hole 231 may be formed approximately at the center of the cap plate 230. At least a portion of the terminal plate 210 may be inserted into the terminal hole 231 and joined to the cap plate 230 with the insulator 220 interposed between the terminal plate 210 and the cap plate 230. That is, the insulator 220 may be arranged between the terminal plate 210 and the cap plate 230. Because the insulator 220 has an adhesive layer on the surface thereof, the insulator 220 may be closely attached to the terminal plate 210 and the cap plate 230, thereby joining the terminal plate 210 to the cap plate 230. The insulator 220 may be composed of an insulating material and may electrically insulate the terminal plate 210 and the cap plate 230 from each other.

By way of summation and review, in small secondary batteries such as coin cells, the thickness of a case or a cap assembly may be made thin to increase the capacity of the electrode assembly that may be accommodated in the case. However, in the case of aluminum used as a terminal plate of a cap assembly in coin cells, as the thickness decreases, the possibility of damage by the charge/discharge pins or external impact increases. Accordingly, an insulator between the terminal plate and the cap plate or the case may be destroyed, resulting in a short circuit. In a case where two materials for different electrodes in a secondary battery come into electrical contact with each other and thus an internal circuit short occurs, the temperature of the secondary battery may rapidly increase, and in serious cases, it may lead to a fire.

Therefore, aspects of embodiments of the present disclosure provide a cap assembly, a secondary battery, and a method for manufacturing the cap assembly where a thickness of the cap assembly is formed thinly to increase energy density in the secondary battery, while damage to the insulator by an external impact and a short circuit may be prevented or substantially minimized. In addition, according to various embodiments of the present disclosure, the durability of the insulator of the cap assembly is increased while adding a waterproof function, thereby preventing deterioration of the secondary battery due to moisture.

However, aspects and features of the present disclosure are not limited to those described above, and other aspects and features not mentioned will be clearly understood by a person skilled in the art from the detailed description, described above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A cap assembly, comprising:
a cap plate having a terminal hole therein;
a terminal plate inserted into the terminal hole and joined to an upper portion of the cap plate; and
an insulator between the cap plate and the terminal plate, the insulator including an aromatic polyamide and a resin composition.

2. The cap assembly as claimed in claim 1, wherein the insulator includes:
an insulating layer including the aromatic polyamide impregnated by the resin composition; and
an adhesive layer on at least one surface of the insulating layer.

3. The cap assembly as claimed in claim 2, wherein the insulating layer includes the aromatic polyamide having a plurality of pores extending vertically therethrough.

4. The cap assembly as claimed in claim 3, wherein the insulating layer has a porosity of 10% or more and 90% or less.

5. The cap assembly as claimed in claim 3, wherein the insulating layer includes the resin composition in the plurality of pores of the aromatic polyamide.

6. The cap assembly as claimed in claim 2, wherein the aromatic polyamide has a form of a woven fabric in which warp and weft yarns intersect each other.

7. The cap assembly as claimed in claim 2, wherein the insulating layer includes a plurality of stacked aromatic polyamide layers.

8. The cap assembly as claimed in claim 1, wherein the insulator has a thickness of 10 μm to 200 μm.

9. The cap assembly as claimed in claim 1, wherein the resin composition includes at least one of a polypropylene resin, an acrylic resin, a synthetic rubber resin, a polyolefin resin, an ester resin, a urethane resin, an epoxy resin, or a silicone resin.

10. A secondary battery, comprising:
an electrode assembly including a wound structure of a first electrode, a second electrode, and a separator between the first electrode and the second electrode;
a case having an opening on one side, the case accommodating the electrode assembly; and
a cap assembly joined to the one side of the case to seal the case, the cap assembly including:
a cap plate joined to the opening and having a terminal hole therein,
a terminal plate inserted into the terminal hole, joined to an upper portion of the cap plate, and electrically connected to the first electrode, and
an insulator between the cap plate and the terminal plate, the insulator including an aromatic polyamide and a resin composition.

11. The secondary battery as claimed in claim 10, wherein the insulator includes:
an insulating layer including the aromatic polyamide impregnated by the resin composition; and
an adhesive layer on at least one surface of the insulating layer.

12. A method for manufacturing a cap assembly, the method comprising:
forming an insulator including an aromatic polyamide and a resin composition;
preparing a cap plate having a terminal hole formed therein;
joining the insulator to an upper surface of the cap plate; and
joining a terminal plate to an upper portion of the cap plate so as to cover the terminal hole.

13. The method as claimed in claim 12, wherein forming the insulator includes:
forming an insulating layer by impregnating the resin composition into the aromatic polyamide; and
stacking an adhesive layer on at least one surface of the insulating layer.

14. The method as claimed in claim 13, wherein the insulating layer includes forming the aromatic polyamide to include a plurality of pores extending vertically therethrough.

15. The method as claimed in claim 14, wherein the insulating layer is formed to have a porosity of 10% or more and 90% or less.

16. The method as claimed in claim 14, wherein forming the insulating layer includes impregnating the resin composition between the plurality of pores.

17. The method as claimed in claim 13, wherein the aromatic polyamide is formed in a form of a woven fabric in which warp and weft yarns intersect each other.

18. The method as claimed in claim 13, wherein forming the insulating layer includes stacking a plurality of aromatic polyamide layers.

19. The method as claimed in claim 12, wherein forming the insulator include forming the insulator to a thickness of 10 μm to 200 μm.

20. The method as claimed in claim 13, wherein forming the insulator includes using for the resin composition at least one of a polypropylene resin, an acrylic resin, a synthetic rubber resin, a polyolefin resin, an ester resin, a urethane resin, an epoxy resin, or a silicone resin.
